(19) United States
(12) Patent Application Publication
(10) Pub. No.: US 2024/0104527 A1
(43) Pub. Date: Mar. 28, 2024

(54) NETWORK-AGNOSTIC SYSTEM TO FACILITATE PEER-TO-PEER TRANSFERS

(71) Applicant: IPCO 2012 LIMITED, LONDON (GB)

(72) Inventors: Elena Gladkaya, London (GB); Michael Gradwell, London (GB); Faizan Husain, London (GB); Kuldeep Kumar, Dunstable (GB); Arundhati Chandrasekhar, Stamford, CT (US)

(21) Appl. No.: 17/955,100

(22) Filed: Sep. 28, 2022

(51) Int. Cl. G06Q 20/10; G06Q 20/02; H04L 67/104

(52) U.S. Cl. CPC G06Q 20/10; G06Q 20/027; H04L 67/104

(57) ABSTRACT

A network-agnostic processor (NAP) is configured to receive, from a first account-holding institution (AHI), an alias request to initiate a transfer. The NAP queries directory servers to retrieve one or more account numbers associated with the alias, transmits a response to the first AHI including the one or more account numbers, receives a P2P transfer request specifying one of the account numbers, and transmits an approval to an originating institution. The approval specifies one or more payment networks capable of clearing and settling funds between an initiating account and the specified account number. The originating institution is one of the first AHI or a second AHI associated with the specified account number. The NAP causes initiation of clearing and settlement of a funds transfer between the initiating account and the specified account number via a designated settlement system network (DSSN) that is one of the specified payment networks.

### BACKGROUND

The field of the disclosure relates generally to enabling peer-to-peer transfers, and more particularly, to systems and methods for facilitating network-agnostic transfers through a peer-to-peer service for any two users.

Consumers and businesses often prefer to pay friends, family, businesses or other entities digitally through a peer-to-peer (P2P) money transfer service. However, in some known P2P systems, both the sender and recipient are required to register with the same money transfer service and/or download the same dedicated money transfer application in order to make an account-to-account (A2A) transaction. Moreover, some known P2P transfer systems are owned by a clearing and settlement network, and are limited to funds transfers between accounts that are both reachable on that specific clearing and settlement network.

In some known systems, if a sender wishes to transfer funds to a recipient who is unregistered in the money transfer system used by the sender, the sender may provide contact information for the recipient, such as an email address or a telephone number. The money transfer service will use this information to contact the intended recipient via an email or text (e.g., with a link to accept the payment). However, if the recipient wishes to accept the payment, the link forces the recipient to provide the recipient's account details manually and/or to register the account directly with the service. In addition, the link may force the recipient to visit a website of, and/or download a dedicated application provided by, the money transfer service. Many consumers do not wish to share account information with, visit a website of, and/or download an application from, a new and/or unfamiliar service.

Accordingly, there is a need to enable P2P funds transfer for consumers using a system that does not require the consumers to register with a new or unfamiliar service, and is not limited to transfers among accounts that are all tied to one clearing and settlement network.

### BRIEF DESCRIPTION OF THE DISCLOSURE

In one aspect, a network-agnostic processor (NAP) server is provided. The NAP server includes at least one processor in communication with a memory device, and the memory device includes instructions executable to cause the least one processor to receive, from a first server associated with a first account-holding institution, an alias request message indicating a request from an initiating user to initiate a transfer. The alias request message includes an alias. The instructions are also executable to cause the least one processor to, in response to the alias request message, query one or more directory servers on the alias, wherein the query returns one or more account numbers associated with the alias. The instructions are further executable to cause the least one processor to transmit an alias response message to the first server including the one or more account numbers, receive, from the first server, a P2P transfer request message specifying one of the one or more account numbers, and, in response to the P2P transfer request message, transmit a transfer approval message to an originating institution server. The transfer approval message specifies one or more payment networks capable of clearing and settling funds between an account of the initiating user and the specified account number. The originating institution server is one of i) a second server associated with a second account-holding institution associated with the specified account number or ii) the first server. Additionally, the instructions are executable to cause the least one processor to cause initiation of clearing and settlement of a funds transfer between the account of the initiating user and the specified account number via a designated settlement system network (DSSN), wherein the DSSN is one of the specified one or more payment networks and operates without interaction with the NAP server.

In another aspect, a method for performing a P2P transfer is provided. The method is conducted by a network-agnostic processor (NAP) server including at least one processor in communication with a memory device, and includes steps performed by the least one processor of receiving, from a first server associated with a first account-holding institution, an alias request message indicating a request from an initiating user to initiate a transfer. The alias request message includes an alias. The steps also include, in response to the alias request message, querying one or more directory servers on the alias, wherein the query returns one or more account numbers associated with the alias. The steps also include transmitting an alias response message to the first server including the one or more account numbers, receiving, from the first server, a P2P transfer request message specifying one of the one or more account numbers, and, in response to the P2P transfer request message, transmitting a transfer approval message to an originating institution server. The transfer approval message specifies one or more payment networks capable of clearing and settling funds between an account of the initiating user and the specified account number. The originating institution server is one of i) a second server associated with a second account-holding institution associated with the specified account number or ii) the first server. Additionally, the steps include causing initiation of clearing and settlement of a funds transfer between the account of the initiating user and the specified account number via a designated settlement system network (DSSN), wherein the DSSN is one of the specified one or more payment networks and operates without interaction with the NAP server.

In another aspect, at least one non-transitory computer-readable medium for use with a network-agnostic processor (NAP) server is provided. The at least one non-transitory computer-readable medium includes instructions embodied thereon, wherein the instructions are executable by at least one processor of the NAP server to cause the least one processor to receive, from a first server associated with a first account-holding institution, an alias request message indicating a request from an initiating user to initiate a transfer. The alias request message includes an alias. The instructions are also executable to cause the least one processor to, in response to the alias request message, query one or more directory servers on the alias, wherein the query returns one or more account numbers associated with the alias. The instructions are further executable to cause the least one processor to transmit an alias response message to the first server including the one or more account numbers, receive, from the first server, a P2P transfer request message specifying one of the one or more account numbers, and, in response to the P2P transfer request message, transmit a transfer approval message to an originating institution server. The transfer approval message specifies one or more payment networks capable of clearing and settling funds between an account of the initiating user and the specified account number. The originating institution server is one of i) a second server associated with a second account-holding institution associated with the specified account number or ii) the first server. Additionally, the instructions are executable to cause the least one processor to cause initiation of clearing and settlement of a funds transfer between the account of the initiating user and the specified account number via a designated settlement system network (DSSN), wherein the DSSN is one of the specified one or more payment networks and operates without interaction with the NAP server.

### BRIEF DESCRIPTION OF THE DRAWINGS

FIG. 1 is a schematic diagram illustrating an example embodiment of a system for facilitating transfer of funds between any two accounts using a network-agnostic processor.

FIG. 2 is a schematic flow diagram for an example peer-to-peer (P2P) “push” transfer using the system shown in FIG. 1, where an alias of the recipient maps to a bank account.

FIG. 3 is a schematic flow diagram for a P2P “push” transfer using the system shown in FIG. 1, where an alias of the recipient maps to a payment card account.

FIG. 4 is a schematic flow diagram for a P2P “push” transfer using the system shown in FIG. 1, where the sender directly provides the recipient's bank account number.

FIG. 5 is a schematic flow diagram for a P2P “push” transfer using the system shown in FIG. 1, where the sender directly provides the recipient's payment card account number.

FIG. 6 is a schematic flow diagram for a P2P “pull” transfer to a bank account of the recipient using the system shown in FIG. 1, where the recipient provides an alias of the sender.

FIG. 7 is a schematic flow diagram for a P2P “pull” transfer to a payment card account of the recipient using the system shown in FIG. 1, where the recipient provides an alias of the sender.

FIG. 8 is a schematic partial flow diagram for a P2P “pull” transfer using the system shown in FIG. 1, where the recipient directly provides the sender's bank account number or payment card account number.

FIG. 9 is a schematic flow diagram for an example request for data (RFD) using the system shown in FIG. 1.

FIG. 10 is a schematic flow diagram for another example request for data (RFD) using the system shown in FIG. 1.

FIG. 11 is a schematic diagram of an example user computing device that may be used with the system shown in FIG. 1.

FIG. 12 is a schematic diagram of an example server computing device that maybe used with the system shown in FIG. 1.

FIG. 13 is a schematic diagram of an example method for performing a P2P transfer that may be performed by the network-agnostic processor of the computer system shown in FIG. 1.

### DETAILED DESCRIPTION

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

The systems and methods described in the present disclosure enable account-agnostic and network-agnostic peer-to-peer (P2P) funds transfers. The term “agnostic” in this context means maintaining funds transfer freedom by not requiring consumers to register individually with a particular payment provider, download a dedicated P2P app from a particular payment provider, or open an account serviced on a particular clearing and settlement network in order to enable the P2P transfer. In other words, two users do not have to be individually registered with the same payment system provider or download the same peer-to-peer payment app in order to transfer money between them. Instead, using the systems and methods disclosed herein, consumers can use the NAP seamlessly via a trusted banking application provided by their existing account-hosting institution (e.g., a bank or digital wallet provider) to initiate a funds transfer to any other individual or institution. In other words, it is the account-holding institution (AHI) that registers for, and presents the user interface for, the P2P transfer service to individuals who hold accounts at the AHI. Accordingly, the individual users do not have to download a separate dedicated application or access an unfamiliar website in order to gain access to the P2P transfer service.

Moreover, the NAP is not limited to transfers among accounts that are all reachable by a particular clearing and settlement network. In many cases, when consumers request a P2P transfer, the NAP service enables the originating financial institution to choose the payment network for clearing and settling that particular transfer between the originating financial institution and the receiving financial institution. The payment network for a given P2P transfer may be selected from among, for example, various payment card processing networks and/or a real-time bank-account debit network. For example, the clearing and settlement networks for five peer-to-peer funds transfers initiated by a single user to five different aliased accounts could be the Mastercard® network, the VISA® network, the Discover® network, the AMEX® network, and an ACH network. Accordingly, in addition to reducing the restrictions of conventional P2P services as discussed above, the NAP service described herein enables institutions hosting the accounts to maintain ownership and control of the clearing and settlement process, as well as providing the institutions with flexibility to integrate the P2P service within their own consumer-facing banking services and applications.

A customer of the service provided by the NAP through the customer's account-holding institution can be provided with customizations including which alias is to be used (e.g., email address, telephone number, eWallet identifier, tax identifier) as an acceptable identifier for the customer, which accounts of the customer are linked, how to accept payments, whether to enable payments to be accepted automatically, manually, or on a scheduled or recurring basis, whether and how to split payments, and a payment threshold limit (e.g., a limit on a number or monetary value of payments that can be made through the service).

In the example embodiment, the NAP can accommodate both push-type requests (e.g., the initiator is the sender of funds to the recipient) and pull-type requests (e.g., the initiator is the recipient of funds from the sender). Moreover, in the example embodiment, the NAP can accommodate requests for data which can then be used to screen the other party or pre-verify the connectivity needed for the transfer.

For example, the user may initiate a push transfer by identifying the recipient by alias (e.g., an email address, a telephone number, etc.) or by an account (e.g., a bank account number, a payment card primary account number (PAN)). The service may be available only after authentication of the user by the banking application. The user may select to push a payment one time or to set up a recurring payment. The user may be able to “save” the recipient alias in the banking application for quick selection for future payments. The user also inputs into the banking application the amount of funds to be transferred and may include an optional note.

In the example embodiment, after the banking application submits the request to the AHI, which can be referred to as the originating institution (OI) for the push transfer, the OI forwards the request to the NAP, and the NAP queries one or more consumer alias directory servers for one or more account numbers associated with the alias. The directory servers may include directories associated with one or more global payments providers, such as Mastercard®, and/or may include various local proxy servers. If the query results indicate that the alias refers to one or more valid accounts, the NAP may transmit a message back to the OI listing the one or more accounts. For example, if the NAP locates the recipient's alias in a directory server as associated with a bank account number, the NAP retrieves the bank account number, and passes it back to the OI. Similarly, if the NAP locates the recipient's alias in a directory server as associated with a payment card account number (e.g., a PAN), the NAP retrieves the payment card account number, and passes it back to the OI. If the query on the alias returns multiple account numbers, the NAP may return all of the account results to the OI, and the OI may select which recipient account to use based on OI and/or user preferences. In some embodiments, the sender's personally identifiable information (PII) is sent as well to enable the receiving institution to perform a sanction screening to ensure, for example, that the sender is not on any prohibited lists. In situations in which the systems discussed herein collect personal information about individuals, or may make use of such personal information, the individuals may be provided with an opportunity to control whether such information is collected or to control whether and/or how such information is used. In addition, certain data may be processed in one or more ways before it is stored or used, so that personally identifiable information is removed, encrypted, or otherwise securely handled.

In the alternative, if the user identifies the recipient's intended bank account number or payment card account number directly, the NAP omits the step of querying the directories based on an alias.

The OI sends a peer-to-peer (P2P) transfer request to the NAP identifying one of the accounts returned by the query (or the account specified directly by the user). The NAP identifies an AHI (which may be referred to as the receiving institution (RI) for the push transfer) associated with the account selected for the P2P transfer request. For example, if the account is a bank account, the bank account number returned from the one or more directory servers (or specified by the sender) may also include a bank routing number of the RI holding the account. For another example, if the account is a payment card account, a bank identification number (BIN) of the RI may be extracted from the payment card account number. The NAP then determines whether the RI participates in the P2P transfer service provided by the NAP. For example, AHIs may pre-register with the NAP to participate in the service, and the same AHI may participate as an RI in some transactions and as an OI in other transactions. If the RI participates, the NAP may send a notification of the P2P transfer request to the RI. The participating RI checks any stored user preferences of the recipient as to whether the recipient prefers to accept funds automatically or manually, and/or any jurisdictional rules regarding manual acceptance that may apply to the transfer. If an automatic acceptance is available, the RI responds directly with an approval. If manual acceptance is preferred or required, the RI acknowledges the message, contacts the recipient, and then responds with the approval after the recipient's confirmation. In some embodiments, the RI will also pass the recipient's PII back to the OI to enable the OI to perform screening of the recipient. In the example embodiment, the NAP shares the participating RI response (if any) with the OI.

In some embodiments, the RI may also send a new account number back to the NAP if the recipient chooses to receive funds in an account that is different from the submitted account number that was derived from the directory. The recipient user may configure this option in advance in their settings on the recipient's banking application, or in response to the request from the RI to manually accept the funds. For example, the RI may pass the different account number on to the NAP via an application programming interface (API) provided by the NAP.

Notification to, and approval from, the RI may be omitted if the RI does not participate in the P2P transfer service, and in many instances the P2P push transfer may still be executed, as clearing and settlement is handled without interaction from the NAP, as discussed below.

The NAP also selects at least one suitable payment network (e.g., a real-time bank-account debit network or a payment card network) to serve as the Designated Settlement System Network (DSSN) for clearing and settlement of the funds transfer. For example, the NAP selects the available payment networks for a particular transaction from among multiple potential payment networks based on whether the RI is a member of/participates in the payment network. From among the list provided by the NAP, the OI may then select the DSSN over which to push the funds. For example, different payment networks may impose different costs to the sender, which may drive the OI's choice of DSSN. In some embodiments the RI may submit a preference for the DSSN to be used, although the OI and/or the NAP may override the RI's preference in some circumstances.

If the DSSN is a real-time payment network and the recipient account is a bank account, the NAP provides instructions to the OI that can be implemented by the OI to push funds via the DSSN. The OI then initiates the clearing and transfer of the funds directly via the DSSN using the instructions provided by the NAP. For example, the instructions include the bank routing number of the RI and the bank account number, as well as a data format required for messages to the DSSN. For example, the NAP may refer to a directory of DSSN rules to obtain communication protocol and/or formatting requirements of the DSSN. For example, the DSSN rules may specify a Uniform Resource Identifier (URI) and syntax for calls to a DSSN application programming interface (API) provided by the selected DSSN, including an API call to cause a transfer of funds. Then, the clearing and settlement of the funds is processed via normal operation of the selected DSSN.

On the other hand, if the DSSN is a payment card network and the recipient account is a payment card account number (e.g., a debit card number), the NAP communicates with a bridge platform of the payment card network to verify that the payment card account number is eligible to receive pushed funds, and if so, requests the payment card network to initiate the funds transfer to the payment card account number via the bridge platform. More specifically, most payment card networks do not enable AHIs to directly serve as a gateway to push funds to a payment card. Instead, the payment card network typically provides the bridge platform to initiate push transfers to a payment card.

In the example embodiment, the bridge platform provides a bridge platform application programming interface (API) for initiating push-to-PAN clearing and settling over the payment card network. In the example embodiment, the bridge platform API is hosted and implemented separately from the API provided by the NAP described elsewhere herein. One example of such a bridge platform is the Mastercard® Send (MA Send) platform, which is an application programming interface (API) that enables a requestor to transmit a request to push funds over the “rails” of the Mastercard® payment card network to a PAN. Other payment card networks implement similar platforms. In this context, a payment card network is a closed network tailored for rapid routing and processing of financial transaction data between financial institutions, using a messaging protocol based on a standard such as ISO® 8583. In response to the request from the NAP, the bridge platform invokes (e.g., using a transaction code 28 (TC28) message in the ISO® 8583 protocol) the clearing and settlement process for the funds transfer via the payment card network DSSN.

If there are sufficient funds in the user's account, the clearing and settlement for the P2P transfer is executed via the DSSN, without interaction from the NAP. Upon completion of the push funds transfer, the OI sends a payment notification to the NAP indicating that the payment has been completed, and the NAP forwards the message on to the RI (if the RI participates in the service). Similarly, after the RI receives the funds, the RI informs the recipient, e.g., via the recipient's banking application, and the OI informs the sender of the completed payment, e.g., via the sender's banking application.

For another example, a user may initiate a pull transfer to the user's own account by identifying the sender (i.e., the payor) by an alias of the sender or by an account number of the sender. In other words, the initiating user in this case is the recipient of funds in the P2P transfer. The service may be accessed through the recipient's banking application (i.e., a banking application provided by the AHI that hosts the user's account), and may be available only after authentication of the recipient by the banking application. The recipient may select to pull a payment one time or to set up a recurring pull payment. The recipient may be able to “save” the sender alias in the banking application for quick selection for future payments. The recipient also inputs into the banking application the amount of funds to be transferred and may include an optional note.

In the example embodiment, after the banking application submits the request to the AHI, which can be referred to as the receiving institution (RI) for the pull transfer, the RI forwards the request to the NAP, and the NAP queries one or more consumer alias directory servers for one or more account numbers associated with the alias, as described above. If the query results indicate that the alias refers to one or more valid accounts, the NAP may transmit a message back to the RI listing the one or more accounts, as described above. If the query on the alias returns multiple account numbers, the NAP may return all of the account results to the RI, and the RI may select which recipient account to use based on RI and/or user preferences. In some embodiments, the recipient's PII is sent as well to enable the OI to perform a sanction screening to ensure, for example, that the recipient is not on any prohibited lists.

In the alternative, if the user identifies the sender's intended bank account number or payment card account number directly, the NAP omits the step of querying the directories based on an alias.

The RI sends a P2P transfer request to the NAP identifying the recipient's own account, and one of the sender accounts returned by the query (or the account specified directly by the user). The NAP identifies an AHI (which may be referred to as the originating institution (OI) for the pull transfer) associated with the sender account selected for the P2P transfer request, as described above. The NAP then determines whether the OI participates in the P2P transfer service provided by the NAP. If so, the NAP and OI then cooperate to select a suitable payment network (e.g., a real-time bank-account debit network or a payment card network) to serve as the DSSN for the transaction, as discussed above. For example, the NAP selects at least one potential DSSN for a particular transaction from among multiple potential payment networks based on whether the RI is a member of/participates in the payment network, and the OI then selects the DSSN from among the potential payment network(s) identified by the NAP. In some embodiments the RI may submit a preference for the DSSN to be used, although the OI and/or the NAP may override the RI's preference in some circumstances.

If the DSSN is a real-time payment network and the recipient account is a bank account, the NAP also provides instructions to the OI that can be implemented to transfer the funds via the DSSN, as described above. The participating OI communicates with the sender (e.g., via an SMS text message, a push notification through the sender's banking application, or another suitable channel) and asks the sender to confirm whether the pull payment should be made from the sender's account. If the sender responds to the OI with an approval, the OI then initiates the clearing and settlement of the funds directly via the DSSN using the instructions provided by the NAP. For example, the instructions include the bank routing number of the RI and the bank account number, as well as a data format required for messages to the DSSN, as described above. Then, the clearing and settlement of the funds is processed via normal operation of the selected DSSN. In addition, the OI forwards a payment confirmation to the NAP, which forwards it to the RI. In some embodiments, the OI will also pass the sender's PII back through the NAP to the RI to enable the RI to perform screening of the sender.

On the other hand, if the DSSN is a payment card network and the recipient account is a PAN (e.g., a debit card number), and if the sender responds to the OI with an approval of the pull payment, the OI requests the NAP to communicate with the DSSN to initiate the actual transfer. In response, the NAP communicates with the bridge platform, as discussed above, to verify that the recipient PAN is eligible to receive funds, and if so, requests the payment card network to initiate the funds transfer to the recipient PAN via the bridge platform. In response to the request from the NAP, the bridge platform invokes (e.g., using a transaction code 28 (TC28) message in the ISO® 8583 protocol) the clearing and settlement process for the funds transfer via the payment card network DSSN. If there are sufficient funds in the user's account, the transaction is executed.

Upon completion of the pull funds transfer, the bridge platform sends a payment notification to the NAP indicating that the payment has been completed, and the NAP forwards the message on to both the OI and the RI. Similarly, after the RI receives the funds, the RI informs the recipient, e.g., via the recipient's banking application, and the OI informs the sender of the completed payment, e.g., via the sender's banking application.

For another example, a participating AHI may transmit a request for data (RFD) to the NAP, prior to any P2P transfer request. The NAP may be programmed to accommodate different forms of RFDs. In some embodiments, any account-holding institution (“AHI”), on behalf of a consumer who maintains an account held by the AHI, can submit an RFD for an alias look-up to the NAP. In response, the NAP queries the one or more consumer alias directory servers, as described above, for one or more account numbers associated with the alias. The NAP then informs the AHI whether there is connectivity through the NAP service with any account associated with the alias. For example, the RFD response could indicate that the aliased account is an expired payment card, or is held by an AHI that does not participate in the NAP service. Because an initiating consumer expects that a transaction will be completed once the initiating consumer confirms the transaction on their end, the initiating consumer's AHI may wish to perform such a validation check via an RFD before asking the initiating consumer to confirm that they want to proceed.

Additionally or alternatively, the RFD requests PII of the party associated with the alias or a specified account, to enable pre-screening prior to initiation of a P2P transfer request. The returned data may include, for example, one or more of an alias account identifier (e.g., account number or digital wallet ID), an AHI associated with the aliased account, and/or PII such as a consumer name and/or address associated with the aliased account, etc. For example, in some situations, it is important for the requesting AHI to obtain advance information about an aliased consumer and/or the alias-associated AHI before a potential push or pull transaction with the aliased consumer/AHI is initiated, in order to complete a screening process of the aliased consumer or the alias-associated AHI prior to initiating the payment transaction. In some such embodiments, an RFD supports compliance with jurisdictional regulations and sanctions screening on both sides (i.e., for the recipient's RI and the sender's OI). For example, the sender's OI may need to know whether the recipient is on a list of entities that have been subject to sanctions or other limitations on financial activity by the OI or a governmental entity. In some embodiments, the NAP has the capability to perform sanctions validations on behalf of the requesting AHI. Additionally or alternatively, the NAP provides the aliased account data and the AHI validates the aliased consumer/aliased AHI against sanction lists themselves.

The technical problems addressed by the NAP and associated methods of the disclosure include at least one of (i) requirement of users to submit personal account information to a new or unfamiliar service in order to accept or initiate a P2P transfer with certain other users; (ii) requirement of users to download an application and/or visit a website of a new or unfamiliar service in order to accept or initiate a P2P transfer with certain other users; (iii) inability of conventional systems to handle P2P transfers among accounts that are not all tied to one clearing and settlement network; (iv) inability of an institution holding an account involved in a P2P transfer to select a clearing and settlement network used for the transfer; and (v) inability of a financial institution to integrate functionality into their consumer-facing websites/client applications to enable consumers to participate in P2P transfers with accounts not held by an affiliate of the institution.

A technical effect of the network-agnostic systems and processes described herein is achieved by an originating institution (OI) server and a receiving institution (RI) server by steps including one or more of (i) receiving, from a first account-holding institution (AHI), an alias request message indicating a request from an initiating user (e.g., a sender for a push transfer, or a recipient for a pull transfer) to initiate a transfer, (ii) querying one or more directory servers on the alias, wherein the querying returns one or more account numbers associated with the alias, (iii) transmitting an alias response message to the first AHI including the one or more account numbers, (iv) receiving, from the first AHI, a P2P transfer request message specifying one of the one or more account numbers, (v) in response to the P2P transfer request message, transmitting a transfer approval message to an originating institution specifying one or more payment networks capable of clearing and settling funds between an account of the initiating user and the specified account number, wherein the originating institution is one of the first AHI (e.g., when the first AHI is requesting a push transfer) or a second AHI associated with the specified account number (e.g., when the first AHI is requesting a pull transfer), (vi) causing initiation of clearing and settlement of a funds transfer between the account of the initiating user and the specified account number via a designated settlement system network (DSSN) that is one of the specified one or more payment networks, (vii) causing the initiation of clearing and settlement by transmitting, to the originating AHI, instructions implementable by the originating AHI to transfer funds to the specified account number via the DSSN, and (viii) causing the initiation of clearing and settlement by sending a transfer initiation request message to a bridge platform associated with the DSSN.

The resulting technical benefits achieved by the network-agnostic systems and methods for facilitating peer-to-peer (P2P) transfers disclosed herein include at least one of: (i) enabling users to accept or initiate a P2P transfer with a wide range of other users through the user's own account-holding institution, without the user having to transmit account information to engage in the P2P transfer; (ii) enabling users to accept or initiate a P2P transfer with a wide range of other users using the banking app already provided by the user's own account-holding institution; (iii) providing a clearing and settlement network-agnostic architecture that enables P2P transfers among accounts that are not all tied to one clearing and settlement network; (iv) enabling an institution holding an account involved in a P2P transfer to select the clearing and settlement network used for the transfer; and (v) enabling financial institutions to integrate functionality into their consumer-facing websites/client applications to enable consumers to participate in P2P transfers with accounts not held by an affiliate of the institution.

Described herein are computer systems such as a network-agnostic processor server (NAP), an originating institution (OI) server, and a receiving institution (RI) server. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a non-transitory computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “payment account” includes payment card accounts, bank accounts, stored valued accounts, mobile wallets, etc., and “payment card” refers to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), wearable computing devices, key fobs, and/or any other computing devices capable of providing account information. Moreover, “payment cards” are not limited to physical devices but rather refer generally to payment credentials. In addition, consumer account behavior can include but is not limited to purchases, management activities (e.g., balance checking), bill payments, achievement of targets (meeting account balance goals, paying bills on time), and/or product registrations (e.g., mobile application downloads).

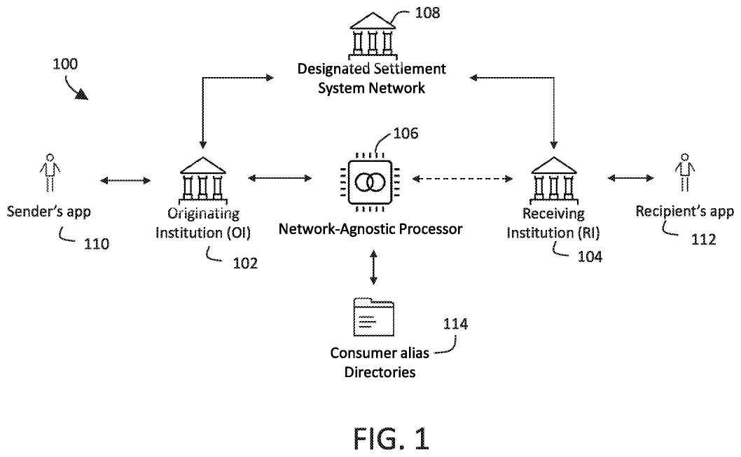

FIG. 1 is a schematic diagram illustrating an example embodiment of a system 100 for facilitating transfer of funds between any two accounts using a network-agnostic processor. In particular, system 100 includes an originating institution (OI) server 102, a receiving institution (RI) server 104, and a network-agnostic processor (NAP) server 106 in communication between OI server 102 and RI server 104.

NAP server 106 facilitates transfer of funds between any two accounts across various OIs and RIs. In particular, NAP server 106 can facilitate transfer of funds to any account provided that RI 104 either issues payment cards tied to a specific Primary Account Number (PAN) (e.g., TC-28 enabled cards on the Mastercard® payment network) or is part of the same real-time payments network as OI 102. A sender's banking application 110 or a recipient's banking application 112 can be used to initiate the account-to-account funds transfer through NAP server 106. For example, applications (or “apps”) 110 and 112 are client applications supported by the respective OI server 102 and RI server 104 as part of general online banking access provided to their customers. A request for a funds transfer from app 110 (a “push” of funds from the sender) or 112 (a “pull” of funds from the sender by the recipient) may specify an alias of the other party to the transfer, such as an email address or mobile phone number. OI server 102 or RI server 104, as the case may be, then sends the request to NAP server 106. NAP server 106 maps the alias to an account number using one or more consumer alias directories 114. For example, the account number is a credit card PAN, a debit card PAN, a digital wallet identifier, a bank savings account number, or a bank checking account number. In some embodiments, NAP server 106 may query multiple consumer alias directories on the alias to find a mapping to an account number, and/or may find multiple account numbers mapped to the alias. (Although two directories 114 are illustrated, it should be understood that any suitable number of directories may be queried by NAP server 106.) NAP server 106 may provide the one or more account numbers returned from the query(ies) to the requesting institution (OI server 102 or RI server 104). The accountholders (via their respective banking applications 110 and 112) may be provided with notifications and opportunities to confirm that the funds transfer should proceed, and the requesting institution may respond to NAP server 106 with a confirmation to proceed with the funds transfer. NAP server 106 also identifies one or more payment networks capable of clearing and settling a funds transfer between the particular OI server 102 and RI server 104 hosting the accounts involved in the transfer. OI 102 selects one of the one or more payment networks as a Designated Settlement System Network (DSSN) 108. NAP server 106 may also send instructions to OI server 102 for making the funds transfer using the selected DSSN 108, enabling OI server 102 to complete the funds transfer with RI 104 using the DSSN 108. The process is explained below in more detail for various use cases.

In some embodiments, NAP server 106 enables communications with OI server 102 and RI server 104 by providing an NAP application programming interface (API) that supports calls from OI server 102 and RI server 104, as appropriate, for push and pull alias requests, peer-to-peer (P2P) push and pull transfer requests, and requests for data (RFD) as API service requests and sends responses to OI server 102 and RI server 104 as API service responses. In other embodiments, NAP server 106 provides any suitable communications framework for implementing the communications described herein.

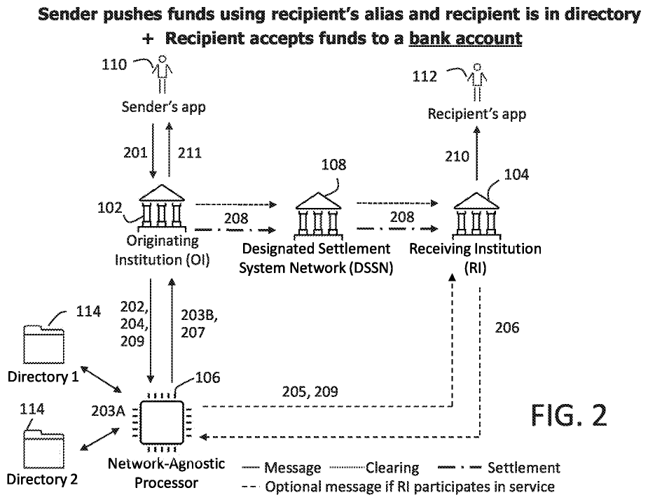

FIG. 2 is a schematic flow diagram for an example peer-to-peer (P2P) “push” transfer using system 100, where the recipient's alias maps to a bank account.

In the example embodiment, the initiating user is the sender, who inputs an alias (e.g., an email address, a telephone number) of the intended recipient of the push transfer into sender's banking app 110, which transmits a request 201 to OI server 102 to begin the push payment process. The sender may also use banking app 110 to select an account, such as a bank account or a payment card account, at the originating institution from which the sender desires to send the funds, or banking app 110 may be associated with a default account of the sender. Banking app 110 may require the sender to perform one or more types of authentication (e.g., entry of a PIN, biometric scan by the mobile device executing the banking app) prior to making the push funds option available. The user also inputs into banking app 110 the amount of funds to be transferred, and may include an optional note. Banking app 110 may provide selectable options to the user to push a payment one time or to set up a recurring payment, and/or to save the recipient alias in banking app 110 for quick selection for future payments. OI server 102 submits a corresponding push alias request 202 including the alias to NAP server 106. For example, push alias request 202 is sent as an API call to NAP server 106.

In the example embodiment, in response to receiving the push alias request 202 from OI server 102, NAP server 106 transmits a query 203A to the one or more consumer alias directory servers 114 for one or more account numbers associated with the alias. Query 203A returns one or more account numbers associated with the alias from at least one of the directory servers 114. More specifically, in this use case, query 203A returns a bank account number associated with the recipient's alias. NAP server 106 passes the bank account number in an alias response message 203B, responsive to the push alias request 202, to OI server 102. For example, NAP server 106 sends alias response message 203B as an API service response to push alias request 202. If query 203A returns multiple account numbers, NAP server 106 may return all of the account results to OI server 102 in alias response message 203B, and OI server 102 may select the bank account number from among the multiple options based on preferences stored by banking app 110 and/or OI server 102. OI server 102 then sends a P2P transfer request 204 including the bank account number to NAP server 106, e.g., via an API call as described above. In some embodiments, P2P transfer request 204 also includes the sender's PII to enable RI server 104 to perform a sanction screening to ensure, for example, that the sender is not on any prohibited lists.

In response to the P2P transfer request 204, NAP server 106 determines whether RI server 104 participates in the service provided by NAP server 106. For example, RI server 104 may send a pre-registration request message (not shown) to NAP server 106, and NAP server 106 may approve the request and store data establishing the participation of RI server 104. If RI server 104 participates, NAP server 106 passes information from P2P transfer request 204 in a notification message 205 to RI server 104. RI server 104 checks any stored user preferences of the recipient as to whether the recipient prefers to accept funds automatically or manually, and/or any jurisdictional rules regarding manual acceptance that may apply to the transfer. If an automatic acceptance is available, the RI server 104 responds directly with an approval message 206 to NAP server 106. If manual acceptance is preferred or required, RI server 104 may first send an acknowledgement message (not shown) to NAP server 106, and communicates with the recipient (e.g., via the recipient's banking app 112, SMS text message, or another suitable channel) to obtain the recipient's approval of receipt of the funds. RI server 104 then sends approval message 206 after the recipient communicates approval. In some embodiments, RI server 104 also includes the recipient's PII in approval message 206 to enable OI server 102 to perform screening of the recipient.

In some embodiments, approval message 206 may also include a substitute account number, for example if the recipient chooses to receive funds in an account that is different from the bank account number returned by query 203A. For example, the API provided by NAP server 106 may support the transmission of a substitute account number in approval message 206. The recipient user may configure the circumstances for providing a new account number in advance in their settings in the recipient's banking app 112, or may select the new account number in response to the request from RI server 104 to manually accept the funds.

In the example embodiment, NAP server 106 shares the RI response with OI server 102 in a transfer approval message 207. For example, NAP server 106 sends transfer approval message 207 as an API service response to P2P transfer request 204. Moreover, transfer approval message 207 also identifies at least one payment network (i.e., a funds clearing and settlement network) capable of completing a transfer to the identified bank account number. For example, NAP server 106 selects the available payment networks for a particular transaction from among multiple potential payment networks based on whether RI server 104 is a member of/participates in the payment network. For example, the payment networks in which RI server 104 participates may have been identified by RI server 104 in the pre-registration process of RI server 104, and/or may be identified/updated in transfer approval message 206. From among the list provided by NAP server 106, OI server 102 then selects one payment network as the Designated Settlement System Network (DSSN) 108 over which to push the funds. For example, different payment networks may impose different costs to the sender, which may drive the choice of DSSN 108 by OI server 102. In some embodiments RI server 104 may identify a preference for the DSSN 108 to be used, although OI server 102 and/or NAP server 106 may override the preference of RI server 104 in some circumstances.

Also in the example embodiment, NAP server 106 provides instructions to OI server 102 that can be implemented to push funds via DSSN 108. For example, if transfer approval message 207 identifies more than one payment network as a potential DSSN 108, transfer approval message 207 may include instructions for each potential payment network, and OI server 102 applies the instructions corresponding to the DSSN 108 selected by OI server 102. Alternatively, in response to transfer approval message 207, OI server 102 notifies NAP server 106 of the selected DSSN 108, and NAP server 106 responds with the instructions for the selected DSSN 108. OI server 102 then sends a funds transfer message 208 via DSSN 108 to accomplish the actual transfer (i.e., clearing and settlement) of the funds separately via DSSN 108. For example, the instructions include the bank routing number associated with RI server 104 and the identified bank account number, as well as a data format required for messages to the selected DSSN 108. In particular, the instructions may specify a Uniform Resource Identifier (URI) and syntax for calls to an API provided by the selected DSSN 108 to cause a transfer of funds. The clearing and settlement of the funds is processed via normal operation of the selected DSSN 108, without involvement by NAP server 106.

Upon completion of the push funds transfer initiated by funds transfer message 208, OI server 102 sends a payment notification message 209 to NAP server 106 indicating that the payment has been completed, and OI server 102 sends a confirmation message 211 to the sender, e.g., via the sender's banking app 110, an SMS text message, or another suitable channel, that the requested P2P push payment was completed. If RI server 104 participates in the service, NAP server 106 forwards message 209 (or a message including similar content) on to RI server 104. Similarly, after RI server 104 receives the funds transfer initiated by funds transfer message 208, RI server 104 sends a funds received message 210 to the recipient, e.g., via the recipient's banking app 112, an SMS text message, or another suitable channel.

In some embodiments, NAP server 106 enables OI server 102 to complete the push funds transfer via DSSN 108 even absent participation of RI server 104 in the service. More specifically, NAP server 106 identifies the aliased bank account number and the bank routing number of the associated RI server 104, as well as one or more payment networks capable of clearing and settling transfers between OI server 102 and RI server 104 (e.g., based on the bank routing number), and provides the instructions to OI server 102, as described above but without sending notification message 205 to, or receiving approval message 206 from, RI server 104 (and also without forwarding message 209 (or a message including similar content) on to RI server 104. Because DSSN 108 operates without interaction from NAP server 106, such a push transfer will be successful absent some restriction on the bank account number which has not yet been reflected in directories 114.

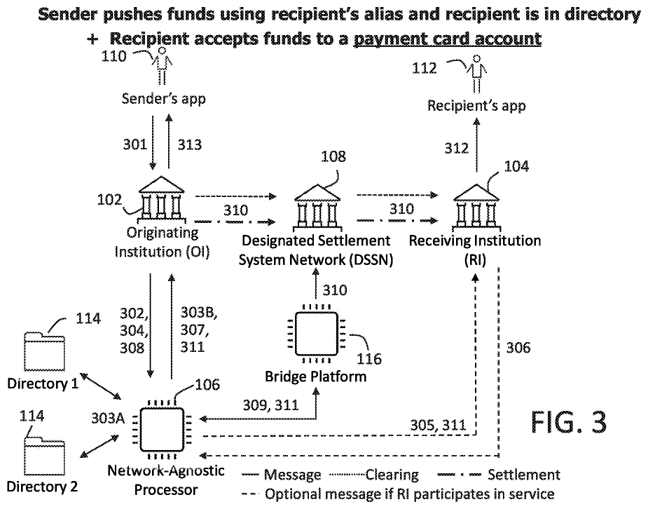

FIG. 3 is a schematic flow diagram for an example P2P “push” transfer using system 100, where the recipient's alias maps to a payment card account.

In the example embodiment, the initiating user is again the sender, who inputs an alias (e.g., an email address, a telephone number) of the intended recipient of the push transfer into sender's banking app 110, which transmits a request 301 to OI server 102 to begin the push payment process, with similar information and options as described above, and OI server 102 submits the corresponding push alias request 302 including the alias to NAP server 106. For example, push alias request 302 is sent as an API call to NAP server 106. In response, NAP server 106 transmits the query 303A to the one or more consumer alias directory servers 114 for one or more account numbers associated with the alias, and query 303A returns one or more account numbers associated with the alias from at least one of the directory servers 114. More specifically, in this use case, query 303A returns a payment card account number associated with the recipient's alias. NAP server 106 passes the payment card account number in an alias response message 303B, responsive to the push alias request 302, to OI server 102. For example, NAP server 106 sends alias response message 303B as an API service response to push alias request 302. If query 303A returns multiple account numbers, NAP server 106 may return all of the account results to OI server 102 in message 303B, and OI server 102 may select the payment card account number from among the multiple options based on preferences stored by banking app 110 and/or OI server 102. OI server 102 then sends P2P transfer request 304 including the payment card account number to NAP server 106, e.g., via an API call as described above. In some embodiments, P2P transfer request 304 again includes the sender's PII to enable RI server 104 to perform a sanction screening to ensure, for example, that the sender is not on any prohibited lists.

In response to the P2P transfer request 304, NAP server 106 determines whether RI server 104 participates in the service provided by NAP server 106, as described above. If RI server 104 participates, NAP server 106 passes information from P2P transfer request 304 in a notification message 305 to RI server 104. RI server 104 checks any stored user preferences of the recipient as to whether the recipient prefers to accept funds automatically or manually, and/or any jurisdictional rules regarding manual acceptance that may apply to the transfer, and as appropriate either checks with the recipient first or directly sends an approval message 306 to NAP server 106, as described above. In some embodiments, RI server 104 again includes the recipient's PII in approval message 306 to enable OI server 102 to perform screening of the recipient. In some embodiments, approval message 306 may also include a substitute account number, for example if the recipient chooses to receive funds in an account that is different from the payment card account number returned by query 303A, as described above.

In the example embodiment, NAP server 106 shares the RI response with OI server 102 in a transfer approval message 307. For example, NAP server 106 sends transfer approval message 307 as an API service response to P2P transfer request 304. Moreover, transfer approval message 307 again identifies at least one payment network (i.e., a funds clearing and settlement network) capable of completing a transfer to the identified payment card account number, e.g., based on whether RI server 104 is a member of/participates in the payment network, as described above, and OI server 102 then selects one payment network as the Designated Settlement System Network (DSSN) 108 over which to push the funds. In some embodiments RI server 104 may again identify a preference for the DSSN 108 to be used, although OI server 102 and/or NAP server 106 may override the preference of RI server 104 in some circumstances.

If the selected DSSN 108 is a payment card network, OI server 102 then transmits a bridge request message 308 to NAP server 106. In response to bridge request message 308, NAP server 106 sends a transfer initiation request 309 to a bridge platform 116 associated with the DSSN 108, as described above, to verify that the payment card account number is eligible to receive pushed funds and request the payment card network to initiate the funds transfer. For example, transfer initiation request 309 is sent as a call to the API provided by bridge platform 116. In response to the request 309, bridge platform 116 verifies the payment card account is eligible to receive pushed funds and sends a funds transfer message 310 (e.g., a transaction code 28 (TC28) message in the ISO® 8583 protocol) to DSSN 108 invoking the clearing and settlement process for the funds transfer via the payment card network DSSN 108. Messages 310 associated with the clearing and settlement process via DSSN 108 are independent from NAP server 106.

Upon completion of the push funds transfer initiated by funds transfer message 310, bridge platform 116 sends a confirmation message 311 to NAP server 106. NAP server 106 forwards confirmation message 311 (or a message including similar content) to OI server 102 and, if RI server 104 participates in the service, to RI server 104. OI server 102 sends a corresponding confirmation message 313 to the sender, e.g., via the sender's banking app 110, an SMS text message, or another suitable channel, that the requested P2P push payment was completed. Similarly, RI server 104 sends a funds received message 312 to the recipient, e.g., via the recipient's banking app 112, an SMS text message, or another suitable channel.

In some embodiments, NAP server 106 again enables OI server 102 to complete the funds transfer via DSSN 108 even absent participation of RI server 104 in the service. More specifically, NAP server 106 identifies the aliased payment card account number and the bank identification number (BIN) of the associated RI server 104, as well as one or more payment networks capable of clearing and settling transfers between OI server 102 and RI server 104 (e.g., based on the BIN), and implements the bridge request 308 from OI server 102, as described above but without sending notification message 305 to, or receiving approval message 306 from, RI server 104 (and also without forwarding message 311 (or a message including similar content) on to RI server 104. Because DSSN 108 operates without interaction from NAP server 106, such a push transfer will be successful absent some restriction on the payment card account number which has not yet been reflected in directory servers 114.

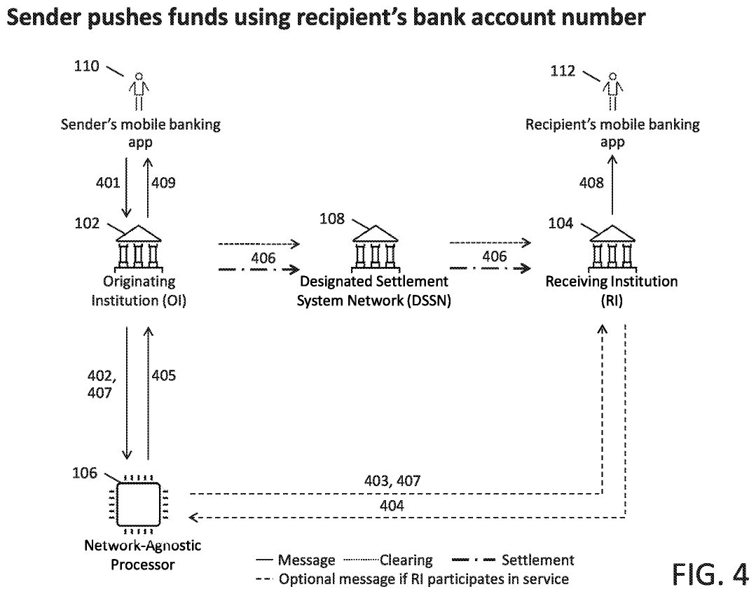

FIG. 4 is a schematic flow diagram for an example account-to-account “push” transfer using system 100, where the sender directly provides the recipient's bank account number.

In the example embodiment, the initiating user is the sender, who inputs the bank account number of the intended recipient of the push transfer into sender's banking app 110. For example, the sender has a trusted relationship with the recipient, such that the recipient is comfortable with providing the bank account number, rather than an alias, to the sender. Sender's banking app 110 transmits a request 401 to OI server 102 to begin the push payment process, with similar information and options as described above (excepting the inclusion of the bank account number rather than an alias), and OI server 102 submits a corresponding P2P transfer request 402 including the bank account number to NAP server 106. For example, P2P transfer request 402 is sent as an API call to NAP server 106. NAP server 106 omits the steps of querying directory servers 114 and returning aliased account numbers to OI server 102, due to the bank account number having been provided directly in the initial message 402. Stated another way, for this use case, P2P transfer request 402 may represent a combination of push request 202 and P2P transfer request 204 (shown in FIG. 2). In some embodiments, P2P transfer request 402 also includes the sender's PII to enable RI server 104 to perform a sanction screening to ensure, for example, that the sender is not on any prohibited lists.

In the example embodiment, in response to receiving P2P transfer request 402 from OI server 102, NAP server 106 again determines whether RI server 104 participates in the service provided by NAP server 106, as described above. If RI server 104 participates, NAP server 106 passes information from P2P transfer request 402 in a notification message 403 to RI server 104. RI server 104 checks any stored user preferences of the recipient as to whether the recipient prefers to accept funds automatically or manually, and/or any jurisdictional rules regarding manual acceptance that may apply to the transfer, and as appropriate either checks with the recipient first or directly sends an approval message 404 to NAP server 106, as described above. In some embodiments, RI server 104 again includes the recipient's PII in approval message 404 to enable OI server 102 to perform screening of the recipient.

In the example embodiment, NAP server 106 shares the RI response with OI server 102 in a transfer approval message 405. For example, NAP server 106 sends transfer approval message 405 as an API service response to P2P transfer request 402. Moreover, transfer approval message 405 again identifies at least one payment network (i.e., a funds clearing and settlement network) capable of completing a transfer to the identified bank account number, e.g., based on whether RI server 104 is a member of/participates in the payment network, as described above, and OI server 102 then selects one payment network as the Designated Settlement System Network (DSSN) 108 over which to push the funds. In some embodiments RI server 104 may again identify a preference for the DSSN 108 to be used, although OI server 102 and/or NAP server 106 may override the preference of RI server 104 in some circumstances.

Also in the example embodiment, NAP server 106 again provides instructions to OI server 102 that can be implemented to push funds via DSSN 108, either initially in transfer approval message 405 or in response to a notification from OI server 102 of the selected DSSN 108 from among the list. OI server 102 then sends funds transfer message 406 via DSSN 108 to accomplish the actual transfer (i.e., clearing and settlement) of the funds separately via DSSN 108. For example, the instructions include the bank routing number associated with RI server 104 and the identified bank account number, as well as a data format required for messages to the selected DSSN 108, and may in particular specify a URI and syntax for calls to the API provided by the selected DSSN 108, as discussed above. The clearing and settlement of the funds is processed via normal operation of the selected DSSN 108, without involvement by NAP server 106.

Upon completion of the push funds transfer initiated by funds transfer message 406, OI server 102 again sends payment notification message 407 to NAP server 106 indicating that the payment has been completed, and OI server 102 sends a confirmation message 409 to the sender, e.g., via the sender's banking app 110, an SMS text message, or another suitable channel, that the requested P2P push payment was completed. If RI server 104 participates in the service, NAP server 106 forwards message 407 (or a message including similar content) on to RI server 104. Similarly, after RI server 104 receives the funds transfer initiated by funds transfer message 406, RI server 104 sends a funds received message 408 to the recipient, e.g., via the recipient's banking app 112, an SMS text message, or another suitable channel.

In some embodiments, NAP server 106 enables OI server 102 to complete the push funds transfer via DSSN 108 even absent participation of RI server 104 in the service. More specifically, NAP server 106 identifies the bank routing number of the associated RI server 104, as well as one or more payment networks capable of clearing and settling transfers between OI server 102 and RI server 104 (e.g., based on the bank routing number), and provides the instructions to OI server 102, as described above but without sending notification message 403 to or receiving approval message 404 from, RI server 104 (and also without forwarding message 407 or a message including similar content on to RI server 104). Because DSSN 108 is able to operate without interaction from or dependence on NAP server 106, such a push transfer will be successful absent some restriction on the bank account number.

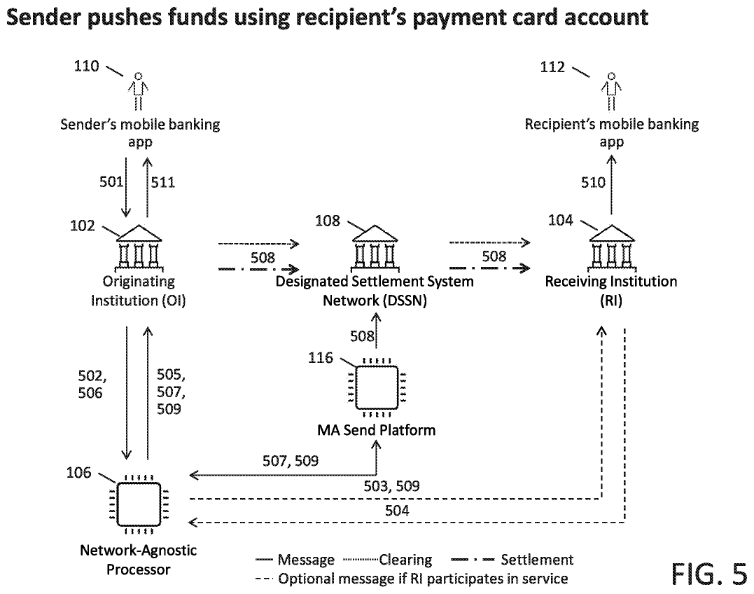

FIG. 5 is a schematic flow diagram for an example account-to-account “push” transfer using system 100, where the sender directly provides the recipient's payment card account number.

In the example embodiment, the initiating user is the sender, who inputs the payment card account number of the intended recipient of the push transfer into sender's banking app 110. For example, the sender has a trusted relationship with the recipient, such that the recipient is comfortable with providing the payment card account number, rather than an alias, to the sender. Sender's banking app 110 transmits a request 501 to OI server 102 to begin the push payment process, with similar information and options as described above (excepting the inclusion of the payment card account number rather than an alias), and OI server 102 submits a corresponding P2P transfer request 502 including the payment card account number to NAP server 106. For example, P2P transfer request 502 is sent as an API call to NAP server 106. NAP server 106 omits the steps of querying directory servers 114 and returning aliased account numbers to OI server 102, due to the payment card account number having been provided directly in the initial message 502. Stated another way, for this use case, P2P transfer request 502 may represent a combination of push request 302 and P2P transfer request 304 (shown in FIG. 3). In some embodiments, P2P transfer request 502 also includes the sender's PII to enable RI server 104 to perform a sanction screening to ensure, for example, that the sender is not on any prohibited lists.

In the example embodiment, in response to receiving P2P transfer request 502 from OI server 102, NAP server 106 again determines whether RI server 104 participates in the service provided by NAP server 106, as described above. If RI server 104 participates, NAP server 106 passes information from P2P transfer request 502 in a notification message 503 to RI server 104. RI server 104 checks any stored user preferences of the recipient as to whether the recipient prefers to accept funds automatically or manually, and/or any jurisdictional rules regarding manual acceptance that may apply to the transfer, and as appropriate either checks with the recipient first or directly sends an approval message 504 to NAP server 106, as described above. In some embodiments, RI server 104 again includes the recipient's PII in approval message 504 to enable OI server 102 to perform screening of the recipient.

In the example embodiment, NAP server 106 shares the RI response with OI server 102 in a transfer approval message 505. For example, NAP server 106 sends transfer approval message 505 as an API service response to P2P transfer request 502. Moreover, transfer approval message 505 again identifies at least one payment network (i.e., a funds clearing and settlement network) capable of completing a transfer to the identified payment card account number, e.g., based on whether RI server 104 is a member of/participates in the payment network, as described above, and OI server 102 then selects one payment network as the Designated Settlement System Network (DSSN) 108 over which to push the funds. In some embodiments RI server 104 may again identify a preference for the DSSN 108 to be used, although OI server 102 and/or NAP server 106 may override the preference of RI server 104 in some circumstances.

OI server 102 then transmits a bridge request message 506 to NAP server 106. In response to bridge request message 506, NAP server 106 sends a transfer initiation request 507 to bridge platform 116 associated with the DSSN 108, as described above. For example, transfer initiation request 507 is sent as a call to the API provided by bridge platform 116. In response to the request 507, bridge platform 116 verifies the payment card account is eligible to receive pushed funds and sends a funds transfer message 508 (e.g., a transaction code 28 (TC28) message in the ISO® 8583 protocol) to DSSN 108 invoking the clearing and settlement process for the funds transfer via the payment card network DSSN 108. Messages 508 associated with the clearing and settlement process via DSSN 108 are independent from NAP server 106.

Upon completion of the push funds transfer initiated by funds transfer message 508, bridge platform 116 sends a confirmation message 509 to NAP server 106. NAP server 106 again forwards confirmation message 509 (or a message including similar content) to OI server 102 and, if RI server 104 participates in the service, to RI server 104. OI server 102 sends a corresponding confirmation message 511 to the sender, e.g., via the sender's banking app 110, an SMS text message, or another suitable channel, that the requested P2P push payment was completed. Similarly, RI server 104 sends a funds received message 510 to the recipient, e.g., via the recipient's banking app 112, an SMS text message, or another suitable channel.

In some embodiments, NAP server 106 again enables OI server 102 to complete the push funds transfer via DSSN 108 even absent participation of RI server 104 in the service. More specifically, NAP server 106 identifies the BIN of the associated RI server 104, as well as one or more payment networks capable of clearing and settling transfers between OI server 102 and RI server 104 (e.g., based on the BIN), and implements the bridge request 506 from OI server 102, as described above but without sending notification message 503 to, or receiving approval message 504 from, RI server 104 (and also without forwarding message 509 (or a message including similar content) on to RI server 104. Because DSSN 108 operates without interaction from NAP server 106, such a transfer will be successful absent some restriction on the payment card account number.

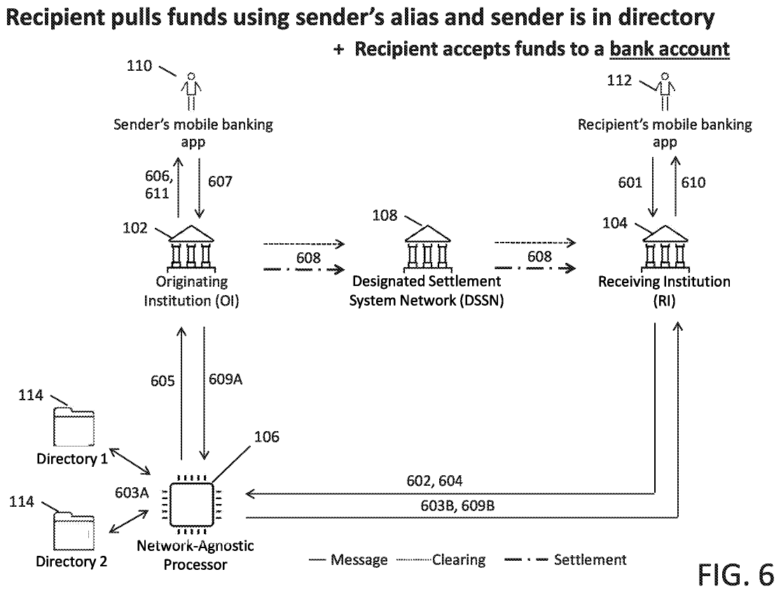

FIG. 6 is a schematic flow diagram for an example account-to-account “pull” funds transfer using system 100, where the recipient provides an alias of the sender and requests to pull the funds to a bank account of the recipient.

In the example embodiment, the initiating user is the recipient of the funds, who inputs an alias (e.g., an email address, a telephone number) of the intended sender of the funds into recipient's banking app 112, which transmits a request 601 to RI server 104 to begin the pull payment process. The recipient may also use banking app 112 to select an account, in this case a bank account, at the receiving institution in which the recipient desires to receive the funds, or banking app 112 may be associated with a default bank account of the recipient. Banking app 112 may require the recipient to perform one or more types of authentication (e.g., entry of a PIN, biometric scan by the mobile device executing the banking app) prior to making the pull funds option available. The user also inputs into banking app 112 the amount of funds to be transferred, and may include an optional note. Banking app 112 may provide selectable options to the user to pull a payment one time or to set up a recurring payment, and/or to save the sender alias in banking app 112 for quick selection for future payments. RI server 104 submits a corresponding pull alias request 602 including the alias to NAP server 106. For example, pull alias request 602 is sent as an API call to NAP server 106.

In the example embodiment, in response to receiving the pull alias request 602 from RI server 104, NAP server 106 transmits a query 603A to the one or more consumer alias directory servers 114 for one or more account numbers associated with the alias. Query 603A returns the account number associated with the alias from at least one of the directory servers 114, such as a bank account number or payment card account number associated with the sender's alias. NAP server 106 passes the one or more account numbers in an alias response message 603B, responsive to the pull alias request 602, to RI server 104. For example, NAP server 106 sends alias response message 603B as an API service response to pull alias request 602. If query 603A returns multiple account numbers, NAP server 106 may return all of the account results to RI server 104 in message 603B, and RI server 104 may select the account number from among the multiple options based on preferences stored by banking app 112 and/or RI server 104. RI server 104 then sends a P2P transfer request 604 including the account number to NAP server 106, e.g., via an API call as described above. In some embodiments, P2P transfer request 604 also includes the recipient's PII to enable OI server 102 to perform a sanction screening to ensure, for example, that the recipient is not on any prohibited lists.

In response to the P2P transfer request 604, NAP server 106 determines whether OI server 102 participates in the service provided by NAP server 106. For example, OI server 102 may send a pre-registration request message (not shown) to NAP server 106, and NAP server 106 may approve the request and store data establishing the participation of OI server 102. If OI server 102 participates, NAP server 106 passes information from P2P transfer request 604 in a transfer approval message 605 to OI server 102. Moreover, transfer approval message 605 also identifies at least one payment network (i.e., a funds clearing and settlement network) capable of completing a transfer to the recipient's bank account number. For example, NAP server 106 selects the available payment networks for a particular transaction from among multiple potential payment networks based on whether RI server 104 is a member of/participates in the payment network. For example, the payment networks in which RI server 104 participates may have been identified by RI server 104 in the pre-registration process of RI server 104, and/or may be identified/updated in approval message 604. From among the list provided by NAP server 106, OI server 102 then selects one payment network as the Designated Settlement System Network (DSSN) 108 over which to push the funds, as described above. In some embodiments RI server 104 may identify a preference for the DSSN 108 to be used, although OI server 102 and/or NAP server 106 may override the preference of RI server 104 in some circumstances.

Also in the example embodiment, NAP server 106 provides instructions to OI server 102 that can be implemented to transfer funds via DSSN 108. For example, if transfer approval message 605 identifies more than one payment network as a potential DSSN 108, transfer approval message 605 may include instructions for each potential payment network, and OI server 102 applies the instructions corresponding to the DSSN 108 selected by OI server 102. Alternatively, in response to transfer approval message 605, OI server 102 notifies NAP server 106 of the selected DSSN 108, and NAP server 106 responds with the instructions for the selected DSSN 108.

In the example embodiment, prior to initiating clearing and settlement, OI server 102 transmits a request 606 for approval (e.g., via the sender's banking app 110, SMS text message, or another suitable channel) to obtain the sender's approval for the pull transfer of the funds from the sender's identified account, and the sender responds to OI server 102 with an approval message 607 via the same or another suitable channel.

OI server 102 then sends a funds transfer message 608 via DSSN 108 to accomplish the actual transfer (i.e., clearing and settlement) of the funds separately via DSSN 108. For example, the instructions include the bank routing number associated with RI server 104 and the identified bank account number of the recipient, as well as a data format required for messages to the selected DSSN 108. In particular, the instructions may specify a URI and syntax for calls to the API provided by the selected DSSN 108, as discussed above. The clearing and settlement of the funds is processed via normal operation of the selected DSSN 108, without involvement by NAP server 106.

Upon completion of the push funds transfer initiated by funds transfer message 608, OI server 102 sends a payment notification message 609A to NAP server 106 indicating that the payment has been completed. In some embodiments, OI server 102 also includes the sender's PII in payment notification message 609A to enable RI server 104 to perform screening of the sender. NAP server 106 forwards message 609A (or a message including similar content) to RI server 104 in payment confirmation message 609B. For example, NAP server 106 sends payment confirmation message 609B as an API service response to P2P transfer request 604. In addition, OI server 102 may send a confirmation message 611 to the sender, e.g., via the sender's banking app 110, an SMS text message, or another suitable channel, that the funds transfer was completed. Similarly, after RI server 104 receives the funds transfer initiated by funds transfer message 608, RI server 104 sends a funds received message 610 to the recipient, e.g., via the recipient's banking app 112, an SMS text message, or another suitable channel, indicating that the requested P2P pull payment was completed.

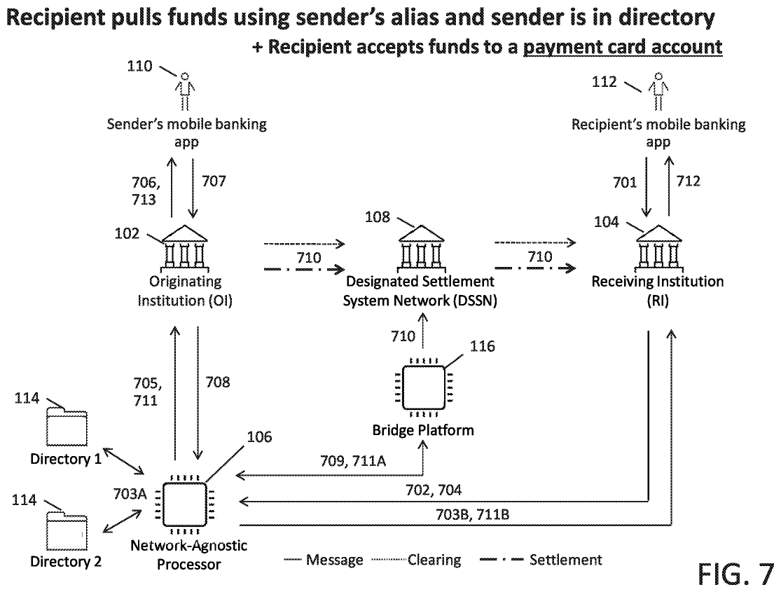

FIG. 7 is a schematic flow diagram for an example account-to-account “pull” transfer using system 100, where the recipient provides an alias of the sender and requests to pull the funds to a payment card account of the recipient.

In the example embodiment, the initiating user is again the recipient, who inputs an alias (e.g., an email address, a telephone number) of the intended sender of the pull transfer into recipient's banking app 112, which transmits a request 701 to RI server 104 to begin the push payment process, with similar information and options as described above. The recipient may use banking app 112 to select an account, in this case a payment card account, at the receiving institution in which the recipient desires to receive the funds, or banking app 112 may be associated with a default payment card account of the recipient. RI server 104 submits the corresponding pull alias request 702 including the alias to NAP server 106. For example, pull alias request 702 is sent as an API call to NAP server 106. In response, NAP server 106 transmits query 703A to the one or more consumer alias directory servers 114 for one or more account numbers associated with the alias. Query 703A returns the account number associated with the alias from at least one of the directory servers 114, such as a bank account number or payment card account number associated with the sender's alias. NAP server 106 passes the one or more account numbers in an alias response message 703B, responsive to the pull alias request 702, to RI server 104. For example, NAP server 106 sends alias response message 703B as an API service response to pull alias request 702. If query 703A returns multiple account numbers, NAP server 106 may return all of the account results to RI server 104 in message 703B, and RI server 104 may select the account number from among the multiple options based on preferences stored by banking app 112 and/or RI server 104. RI server 104 then sends a P2P transfer request 704 including the account number to NAP server 106, e.g., via an API call as described above. In some embodiments, P2P transfer request 704 also includes the recipient's PII to enable OI server 102 to perform a sanction screening to ensure, for example, that the recipient is not on any prohibited lists.

In response to the P2P transfer request 704, NAP server 106 determines whether OI server 102 participates in the service provided by NAP server 106, as described above. If OI server 102 participates, NAP server 106 passes information from P2P transfer request 704 in a transfer approval message 705 to OI server 102. Moreover, transfer approval message 705 again identifies at least one payment network (i.e., a funds clearing and settlement network) capable of completing a transfer to the identified payment card account number, e.g., based on whether RI server 104 is a member of/participates in the payment network, as described above, and OI server 102 then selects one payment network as the Designated Settlement System Network (DSSN) 108 over which to push the funds. In some embodiments RI server 104 may again identify a preference for the DSSN 108 to be used, although OI server 102 and/or NAP server 106 may override the preference of RI server 104 in some circumstances.

In the example embodiment, prior to initiating clearing and settlement, OI server 102 transmits a request 706 for approval (e.g., via the sender's banking app 110, SMS text message, or another suitable channel) to obtain the sender's approval for the pull transfer of the funds from the sender's identified account, and the sender responds to OI server 102 with an approval message 707 via the same or another suitable channel.

If the selected DSSN 108 is a payment card network, OI server 102 then transmits a bridge request message 708 to NAP server 106. In some embodiments, OI server 102 includes the sender's PII in message 708 to enable RI server 104 to perform screening of the sender. In response to bridge request message 708, NAP server 106 sends a transfer initiation request 709 to bridge platform 116 associated with the DSSN 108, as described above, to verify that the payment card account number is eligible to receive pushed funds and request the payment card network to initiate the funds transfer. For example, transfer initiation request 709 is sent as a call to the API provided by bridge platform 116. In response to the request 709, bridge platform 116 verifies the payment card account is eligible to receive pushed funds and sends a funds transfer message 710 (e.g., a transaction code 28 (TC28) message in the ISO® 8583 protocol) to DSSN 108 invoking the clearing and settlement process for the funds transfer via the payment card network DSSN 108. Messages 710 associated with the clearing and settlement process via DSSN 108 are independent from NAP server 106.

Upon completion of the push funds transfer initiated by funds transfer message 710, bridge platform 116 sends a confirmation message 711A to NAP server 106. NAP server 106 forwards confirmation message 711A (or similar content) to OI server 102 and RI server 104 as payment confirmation message 711B. For example, NAP server 106 sends payment confirmation message 711B as an API service response to P2P transfer request 704. Message 711B may include the sender's PII previously provided by OI server 102. OI server 102 sends a corresponding confirmation message 713 to the sender, e.g., via the sender's banking app 110, an SMS text message, or another suitable channel, that the funds transfer was completed. Similarly, RI server 104 sends a funds received message 712 to the recipient, e.g., via the recipient's banking app 112, an SMS text message, or another suitable channel, indicating that the requested P2P pull payment was completed.

With reference to FIGS. 6 and 7, in some cases, NAP server 106 may be unable to resolve the sender's alias into an account, i.e., query 603A or 703A may return null results for the sender's alias. In the example embodiment, in such a case, alias response message 603B or 703B indicates to RI server 104 indicates that the sender's alias could not be resolved, and RI server 104 informs (e.g., via the recipient's banking app 112, SMS text message, or another suitable channel) the recipient who initiated the pull request 601 or 701 that the sender could not be reached. In response, banking app 112 may prompt the recipient to enter another alias for the intended sender, or to directly enter a bank account number or payment card account number of the sender, in order to re-attempt the pull funds request. If the recipient pursues one of these options, banking app 112 initiates a new pull funds request 601, 701, or 801 (described below) as appropriate.

Similarly, in certain cases, alias response message 603B or 703B includes one or more account numbers of the sender returned by query 603A or 703A. However, in response to the P2P transfer request 604 or 704 specifying one of those account numbers, NAP server 106 determines that the corresponding OI server 102 does not participate in the service provided by NAP server 106. In the example embodiment, in such a case, NAP server 106 transmits a message (e.g., in the API service response to the P2P transfer request) to RI server 104 indicating that the originating institution corresponding to the designated sender's account number cannot be reached. In response, RI server 104 may re-send P2P transfer request 604 or 704 specifying a different account number of the sender (e.g., if more than one account number of the sender was returned in alias response message 603B or 703B), or may inform (e.g., via the recipient's banking app 112, SMS text message, or another suitable channel) the recipient who initiated the pull request 601 or 701 that the sender could not be reached (e.g., if no more account numbers of the sender are available), and banking app 112 may also prompt the recipient to enter another alias, another bank account number, or another payment card account number for the intended sender other than those previously attempted to re-attempt the pull funds transfer.

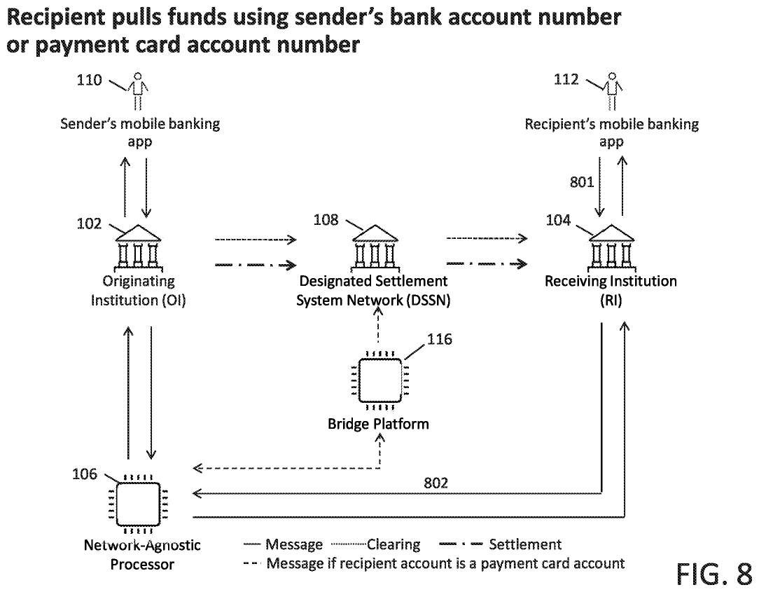

FIG. 8 is a schematic partial flow diagram for an example P2P “pull” transfer using system 100, where the recipient directly provides the sender's bank account number or payment card account number.

In the example embodiment, the initiating user is the recipient, who inputs the bank account number or payment card account number of the intended sender of the funds into recipient's banking app 112. For example, the recipient has a trusted relationship with the sender, such that the sender is comfortable with providing the bank account number or payment card account number, rather than an alias, to the recipient. Recipient's banking app 112 transmits a request 801 to RI server 104 to begin the pull payment process, with similar information and options as described above (excepting the inclusion of the sender's bank account number or payment card account number rather than an alias). The recipient may also use banking app 112 to select an account, in this case either a bank account or a payment card account, at the receiving institution in which the recipient desires to receive the funds, or banking app 112 may be associated with a default bank account or payment card account of the recipient. RI server 104 submits a corresponding P2P transfer request 802 including the sender's bank account number or payment card account number to NAP server 106. For example, P2P transfer request 802 is sent as an API call to NAP server 106. NAP server 106 omits the steps of querying directory servers 114 and returning aliased account numbers to RI server 104, due to the bank account number or payment card account number having been provided directly in the initial message 802. Stated another way, for these use cases, P2P transfer request 802 may represent a combination of pull request 602 or 702 with P2P transfer request 604 or 704 (shown in FIGS. 6 and 7). In some embodiments, P2P transfer request 802 also includes the recipient's PII to enable OI server 102 to perform a sanction screening to ensure, for example, that the recipient is not on any prohibited lists.

In the example embodiment, in response to receiving P2P transfer request 802 from RI server 104, NAP server 106 determines whether OI server 102 participates in the service provided by NAP server 106, as described above. If OI server 102 participates, the process continues with steps 605 through 611 shown in FIG. 6, if the recipient's designated account for receipt of the pulled funds is a bank account, or with steps 705 through 713 shown in FIG. 7, if the recipient's designated account for receipt of the pulled funds is a payment card account.

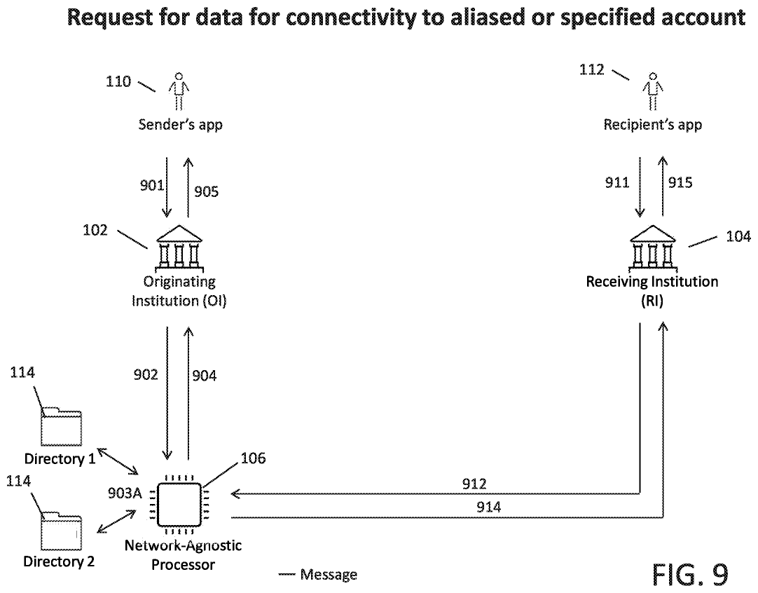

FIG. 9 is a schematic flow diagram for an example request for data (RFD) using system 100.

For example, a sender transmits a push funds request 901 via sender's banking app 110 to OI server 102, including the recipient's alias, corresponding to request 201 or 301 (shown FIGS. 2 and 3), or a specified bank account number or payment card account number, corresponding to request 401 or 501 (shown in FIGS. 4 and 5). Rather than immediately proceeding with the entire funds transfer process, OI server 102 may instead send a request for data (RFD) 902 to NAP server 106 to predetermine connectivity of the recipient for a push transfer using the service provided by NAP server 106. For example, RFD 902 is sent as an API call to NAP server 106.

In the example embodiment, in response to RFD 902, in the case where an alias is provided, NAP server 106 submits a query 903A to the one or more directory servers 114, similar to queries 203A and 303A described above, for one or more account numbers associated with the recipient's alias. If account numbers are returned by the query, NAP server 106 may further check whether the associated RI server 104 participates in the service. Additionally, if one of the accounts is a payment card account, NAP server 106 may check whether the payment card account is eligible to receive a push payment. NAP server 106 then transmits an RFD response 904 to OI server 102 including account data (e.g., bank account number, payment card account number, or digital wallet ID) returned by the query, similar to alias response message 203B or 303B, for accounts that are eligible to receive a push transfer. For example, NAP server 106 sends RFD response 904 as an API service response to RFD 904. In the case where a specified bank account number or payment card account number is provided, NAP server 106 omits the query 903A and returns RFD response 904 indicating whether the associated RI server 104 participates in the service and, if the specified account is a payment card account, whether the payment card account is eligible to receive a push payment.

OI server 102 may relay the results from RFD response 904 as needed in a message 905 to sender's banking app 110, and may proceed with a P2P transfer request, e.g., P2P transfer request 204, 304, 402, or 502, as requested or confirmed by the sender. If no accounts are returned by the query 903A on an alias, or if no returned/specified accounts are held by a participating RI/eligible to receive a push transfer, response 904 may indicate that no push transfer to the alias or specified account is possible, and message 905 to sender's banking app 110 may reflect the same.

Similarly, if a recipient transmits a pull funds request 911 including the sender's alias, corresponding to request 601 or 701 (shown FIGS. 6 and 7), or including a specified bank account/payment card account, corresponding to request 801 (shown in FIG. 8), via recipient's banking app 112 to RI server 104, RI server 104 may send an RFD 912 to NAP server 106 to determine connectivity of the sender for a pull transfer using the service provided by NAP server 106. For example, RFD 912 is sent as an API call to NAP server 106.

In response to RFD 912, in the case where an alias is provided, NAP server 106 proceeds with query 903A and/or checks OI server 102 participation in the service, in a like process to that described above for RFD 902, and returns RFD response 914 to RI server 104, including account data (e.g., bank account number, payment card account number, or digital wallet ID) returned by the query, similar to alias response message 603B or 703B, for accounts that are eligible to be drawn from in a pull transfer. For example, NAP server 106 sends RFD response 914 as an API service response to RFD 912. In the case where a specified bank account number or payment card account number is provided, NAP server 106 omits the query 903A and returns RFD response 914 indicating whether the associated OI server 102 participates in the service. RI server 104 may relay the results as needed in message 915 to recipient's banking app 112, and may proceed with a P2P transfer request, e.g., P2P transfer request 604, 704, or 802, as requested or confirmed by the recipient. If no accounts are returned by the query 903A on an alias, or info returned/specified accounts are held by a participating OI, response 914 may indicate that no pull transfer from the alias or specified account is possible, and message 915 to sender's banking app 110 may reflect the same.

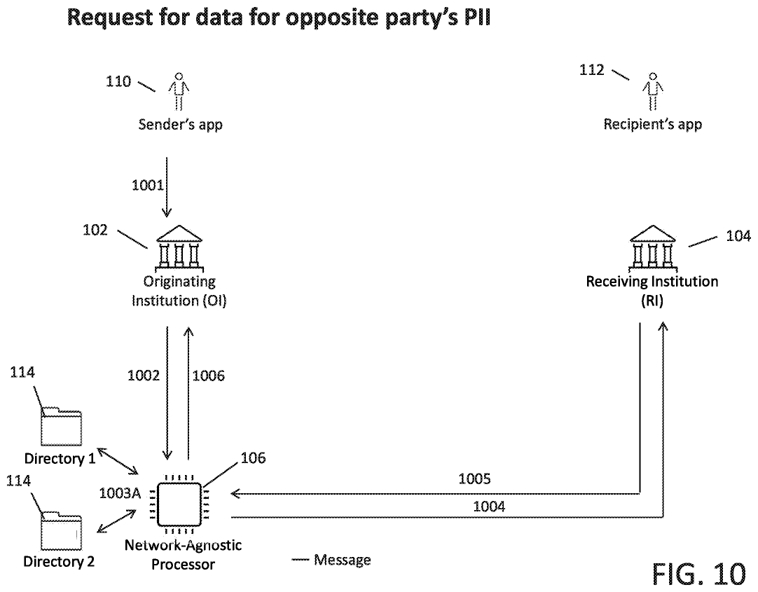

FIG. 10 is a schematic flow diagram for another example request for data (RFD) using system 100. In this example, an account-holding institution (e.g., OI server 102 or RI server 104) may send a request for data (RFD) 1002 to NAP server 106 to retrieve PII of the holder of an opposite account for a screening check, prior to a request for a funds transfer using the service provided by NAP server 106. In the example illustrated in FIG. 10, the sender transmits a push funds request 1001 via sender's banking app 110 to OI server 102, including the recipient's alias, corresponding to request 201 or 301 (shown FIGS. 2 and 3), or a specified bank account number or payment card account number, corresponding to request 401 or 501 (shown in FIGS. 4 and 5). Rather than immediately proceeding with the entire funds transfer process, OI server 102 instead sends a request for data (RFD) 1002 to NAP server 106 to retrieve PII of the recipient for a screening check prior to any push transfer using the service provided by NAP server 106. For example, RFD 1002 is sent as an API call to NAP server 106.

In the case where an alias is provided, NAP server 106 submits a query 1003A to the one or more directory servers 114, similar to query 903A described above, for one or more account numbers associated with the recipient's alias. For the recipient accounts returned by query 1003A, or for the specified recipient accounts in the request 1001, NAP server 106 then determines whether the corresponding RI server 104 participates in the service provided by NAP server 106. If RI server 104 participates, NAP server 106 transmits a request 1004 to RI server 104 for the recipient's PII. RI server 104 returns a response 1005 including the recipient's PII. In the example embodiment, NAP server 106 then provides the aliased account data and the recipient's PII in a RFD response 1006 to OI server 102, and OI server 102 validates the account and RI against sanction lists. For example, NAP server 106 sends RFD response 1006 as an API service response to RFD 1002. In some embodiments, NAP server 106 also has the capability to perform sanctions validations on behalf of the requesting OI server 102, and may return the results of such validations in message 1006.

Although illustrated in FIG. 10 as initiated by the OI server 102, in the example embodiment RFD 1002 can also be sent from RI server 104, e.g. in response to a pull funds request including the sender's alias, corresponding to request 601 or 701 (shown FIGS. 6 and 7), or including a specified bank account/payment card account, corresponding to request 801 (shown in FIG. 8), to enable RI server 104 to screen the intended sender. The process proceeds as described above with the roles of OI server 102 and RI server 104 reversed, i.e., messages 1002 and 1006 are exchanged between RI server 104 and NAP server 106, and messages 1004 and 1005 are exchanged between OI server 102 and NAP server 106.

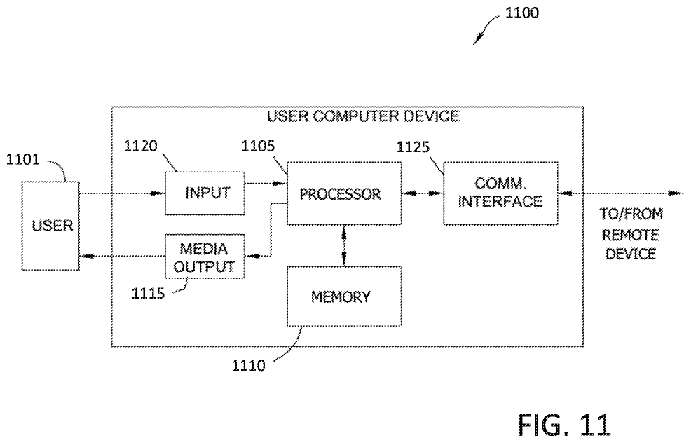

FIG. 11 is a schematic diagram an example configuration of a user computing device 1100, in accordance with some embodiments of the present disclosure. User computer device 1100 may be used to implement, for example, a computing device used by the sender to execute and interact with sender's banking application 110 and/or a computing device used by the recipient to execute and interact with recipient's banking application 112. User computer device 1100 includes a processor 1105 for executing instructions, and a memory area 1110. In some embodiments, executable instructions are stored in memory area 1110. Processor 1105 may, for example, include one or more processing units (e.g., in a multi-core configuration). Memory area 1110 may, for example, be any device allowing information such as executable instructions to be stored and retrieved. Memory area 1110 may further include one or more computer readable media.

In the example embodiment, user computer device 1100 further includes at least one media output component 1115 for presenting information to a user 1101 (e.g., the sender or recipient of a P2P request as discussed above). Media output component 1115 may, for example, be any component capable of converting and conveying electronic information to user 1101. For example, media output component 1115 may be a display component configured to display reports, dashboards, communications, and the like. In some embodiments, media output component 1115 includes an output adapter (not shown), such as a video adapter and/or an audio adapter, which is operatively coupled to processor 1105 and operatively connectable to an output device (also not shown), such as a display device (e.g., a cathode ray tube (CRT), liquid crystal display (LCD), light emitting diode (LED) display, or “electronic ink” display) or an audio output device (e.g., a speaker or headphones).

In some embodiments, user computer device 1100 includes an input device 1120 for receiving input from user 1101. Input device 1120 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, or the like. A single component such as a touch screen may function as both an output device of media output component 1115 and as input device 1120.

User computing device 1100 may also include a communication interface 1125, which is communicatively connectable to a remote device such as OI server 102 or RI server 104. Communication interface 1125 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

User computing device 1100 may be configured to present a user interface to user 1101 via media output component 1115 and, optionally, to receive and process input from input device 1120. In some embodiments, media output component 1115 is configured to present a graphical user interface (not shown), such as a web browser and/or a client application, to user 1101. Web browsers enable users, such as user 1101, to display and interact with media and other information typically embedded on a web page or a website from a server system. A client application allows user 1101 to interact with a server application from the server system. The web browser or client application may include sender's banking app 110 or recipient's banking app 112 interacting with websites and/or server applications hosted by OI server 102 or RI server 104, respectively. For example, instructions may be stored in memory area 1110 and/or by a cloud service, and the output of the execution of the instructions sent to the media output component 1115.

Processor 1105 executes computer-executable instructions for implementing aspects of the disclosure. In some embodiments, the processor 1105 is transformed into a special purpose microprocessor by executing computer-executable instructions or by otherwise being programmed. For example, the processor 1105 may be programmed with instructions such that it may execute the processes of sender's banking app 110 and/or recipient's banking app 112 as illustrated in FIGS. 2-10.

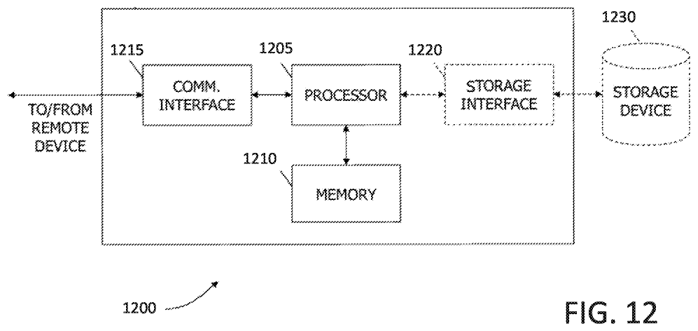

FIG. 12 is a schematic diagram of an example configuration of a server computing device 1200, in accordance with some embodiments of the present disclosure. Server computing device 1200 may be used to implement one or more of OI server 102, RI server 104, NAP server 106, servers of DSSN 108, directory servers 114 (all shown in FIG. 1), or bridge platform 116 (shown in FIG. 3). In the example embodiment, server computing device 1200 includes processor 1205 for executing instructions (not shown) stored in a memory 1210. In an embodiment, processor 1205 may include one or more processing units (e.g., in a multi-core configuration). The instructions may be executed within various different operating systems, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general or specific to a particular programming language (e.g., C, C#, C++, Java, or other suitable programming languages, etc.).

In the example embodiment, processor 1205 is operatively coupled to a communication interface 1215 such that server computing device 1200 is capable of communicating with a remote device, such as a user computing system (e.g., executing sender's banking app 110 or recipient's banking app 112) or another server computing device 1200 (e.g., any of OI server 102, RI server 104, NAP server 106, servers of DSSN 108, directory servers 114, or bridge platform 116). For example, communication interface 1215 may receive requests or other messages from a user computing system or another server via the Internet.

In the example embodiment, processor 1205 is also operatively coupled to a storage device 1230, which may be, for example, a computer-operated hardware unit suitable for storing or retrieving data. In some embodiments, storage device 1230 is integrated into server computing device 1200. For example, device 1200 may include one or more hard disk drives as storage device 1230. In other embodiments, storage device 1230 is external to device 1200 and may be accessed by a plurality of server computing devices 1200. For example, storage device 1230 may include multiple storage units such as hard disks or solid state disks in a redundant array of inexpensive disks (RAID) configuration. Storage device 1230 may include a storage area network (SAN) or a network attached storage (NAS) system. Storage device 1230 may be used as a repository for one or more databases or other data structures for storing various data elements received, processed, and/or generated by one or more of OI server 102, RI server 104, NAP server 106, servers of DSSN 108, directory servers 114, or bridge platform 116.

In some embodiments, processor 1205 is operatively coupled to storage device 1230 via an optional storage interface 1220. Storage interface 1220 may include, for example, a component capable of providing processor 1205 with access to storage device 1230. In an exemplary embodiment, storage interface 1220 further includes one or more of an Advanced Technology Attachment (ATA) adapter, a Serial ATA (SATA) adapter, a Small Computer System Interface (SCSI) adapter, a RAID controller, a SAN adapter, a network adapter, or a similarly capable component providing processor 1205 with access to storage device 1230.

Memory area 1210 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

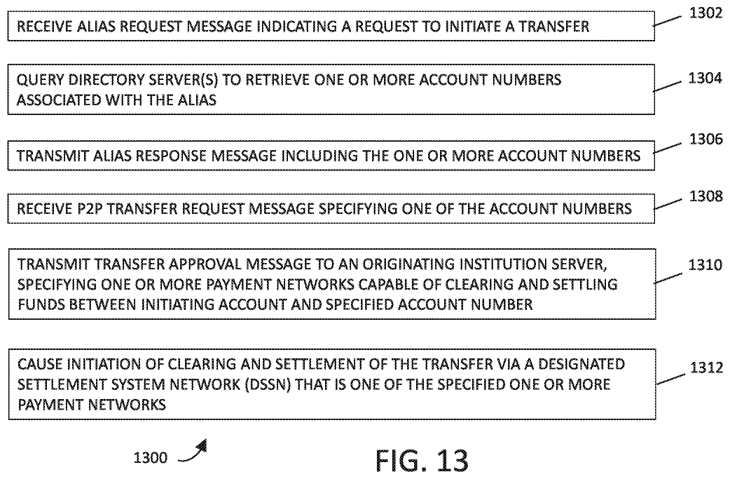

FIG. 13 is a schematic diagram of an example method 1300 for performing a P2P transfer that may be performed by NAP server 106. With reference also to FIGS. 1-12, method 1300 includes steps performed by NAP server 106 including, in the example embodiment, receiving 1302, from a first server (e.g., one of OI server 102 or RI server 104) associated with a first account-holding institution, an alias request message (e.g., message 202, 302, 602, or 702) indicating a request from an initiating user (e.g., the sender for a push transfer, or the recipient for a pull transfer) to initiate a transfer. The alias request message includes an alias. The steps also include, in response to the alias request message, querying 1304 one or more directory servers (e.g., directory servers 114) on the alias, wherein the querying returns one or more account numbers associated with the alias, and transmitting 1306 an alias response message (e.g., message 203B, 303B, 603B, or 703B) to the first server including the one or more account numbers. The steps further include receiving 1308, from the first server, a P2P transfer request message (e.g., message 204, 304, 604, or 704) specifying one of the one or more account numbers, and in response to the P2P transfer request message, transmitting 1310 a transfer approval message (e.g., message 207, 307, 605, or 705) to an originating institution server (e.g., OI server 102). The transfer approval message specifies one or more payment networks capable of clearing and settling funds between an account of the initiating user and the specified account number, and the originating institution server is one of i) a second server associated with a second account-holding institution associated with the specified account number (e.g., when the first server is RI server 104 requesting a pull transfer), or ii) the first server (e.g., when the first server is OI server 102 requesting a push transfer). Additionally, the steps include causing 1312 initiation of clearing and settlement of a funds transfer between the account of the initiating user and the specified account number via a designated settlement system network (DSSN) (e.g., DSSN 108), wherein the DSSN is one of the specified one or more payment networks and operates without interaction with NAP server 106. For example, the step of causing 1312 the initiation of clearing and settlement may include transmitting, to the originating server, instructions implementable by the originating server to transfer funds to the specified account number via the DSSN, as described above. For another example, the step of causing 1312 the initiation of clearing and settlement may include sending a transfer initiation request message to a bridge platform (e.g., bridge platform 116) associated with the DSSN.

Method 1300 may include different and/or additional steps consistent with the functionality of NAP server 106 and/or system 100 as described herein.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, computer-executable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible and fast system for various aspects of passive multi-factor authentication. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A network-agnostic processor (NAP) server comprising at least one processor in communication with a memory device, the memory device including instructions executable to cause the least one processor to:
receive, from a first server associated with a first account-holding institution, an alias request message indicating a request from an initiating user to initiate a transfer, the alias request message including an alias;
in response to the alias request message, query one or more directory servers on the alias, wherein the query returns one or more account numbers associated with the alias;
transmit an alias response message to the first server including the one or more account numbers;
receive, from the first server, a P2P transfer request message specifying one of the one or more account numbers;
in response to the P2P transfer request message, transmit a transfer approval message to an originating institution server, the transfer approval message specifying one or more payment networks capable of clearing and settling funds between an account of the initiating user and the specified account number, wherein the originating institution server is one of i) a second server associated with a second account-holding institution associated with the specified account number or ii) the first server; and
cause initiation of clearing and settlement of a funds transfer between the account of the initiating user and the specified account number via a designated settlement system network (DSSN), wherein the DSSN is one of the specified one or more payment networks and operates without interaction with said NAP server.

2. The NAP server according to claim 1, wherein the instructions are further executable to cause the least one processor to cause the initiation of clearing and settlement by transmitting, to the originating server, instructions implementable by the originating server to transfer funds to the specified account number via the DSSN.

3. The NAP server according to claim 1, wherein the instructions are further executable to cause the least one processor to cause the initiation of clearing and settlement by sending a transfer initiation request message to a bridge platform associated with the DSSN.

4. The NAP server according to claim 3, wherein the bridge platform provides a bridge platform application programming interface (API) for initiating push-to-PAN clearing and settling over the DSSN, and the transfer initiation request message is formatted as a call to the bridge platform API.

5. The NAP server according to claim 1, wherein the instructions are further executable to cause the least one processor to provide an NAP application programming interface (API), and at least one of the alias request message or the P2P transfer request message is formatted as a call to the NAP API.

6. The NAP server according to claim 1, wherein the instructions are further executable to cause the least one processor to:
in response to the P2P transfer request message, determine whether the second server participates in a P2P service provided by said NAP server;
in response to determining that the second server participates, transmit information from the P2P transfer request message in a notification message to the second server; and
receive an approval message from the second server.

7. The NAP server according to claim 1, wherein the instructions are further executable to cause the least one processor to:
receive, from the first server, a second P2P transfer request message specifying a third account number transmitted to the first server by the initiating user;
in response to the second P2P transfer request message, transmit a second transfer approval message to a second originating institution server, the transfer approval message specifying another one or more payment networks capable of clearing and settling funds between the account of the initiating user and the third account number, wherein the second originating institution server is one of i) a third server associated with a third account-holding institution associated with the third account number or ii) the first server; and
cause initiation of clearing and settlement of a second funds transfer between the account of the initiating user and the third account number via a second DSSN, wherein the second DSSN is one of the specified another one or more payment networks and operates without interaction with said NAP server.

8. A method for performing a P2P transfer, said method conducted by a network-agnostic processor (NAP) server including at least one processor in communication with a memory device and comprising steps performed by the least one processor of:
receiving, from a first server associated with a first account-holding institution, an alias request message indicating a request from an initiating user to initiate a transfer, the alias request message including an alias;
in response to the alias request message, querying one or more directory servers on the alias, wherein the querying returns one or more account numbers associated with the alias;
transmitting an alias response message to the first server including the one or more account numbers;
receiving, from the first server, a P2P transfer request message specifying one of the one or more account numbers;
in response to the P2P transfer request message, transmitting a transfer approval message to an originating institution server, the transfer approval message specifying one or more payment networks capable of clearing and settling funds between an account of the initiating user and the specified account number, wherein the originating institution server is one of i) a second server associated with a second account-holding institution associated with the specified account number or ii) the first server; and
causing initiation of clearing and settlement of a funds transfer between the account of the initiating user and the specified account number via a designated settlement system network (DSSN), wherein the DSSN is one of the specified one or more payment networks and operates without interaction with said NAP server.

9. The method according to claim 8, wherein said causing the initiation of clearing and settlement comprises transmitting, to the originating server, instructions implementable by the originating server to transfer funds to the specified account number via the DSSN.

10. The method according to claim 8, wherein said causing the initiation of clearing and settlement comprises sending a transfer initiation request message to a bridge platform associated with the DSSN.

11. The method according to claim 10, wherein the bridge platform provides a bridge platform application programming interface (API) for initiating push-to-PAN clearing and settling over the DSSN, and said sending the transfer initiation request message comprises sending a call to the bridge platform API.

12. The method according to claim 8, wherein the steps further comprise providing an NAP application programming interface (API), and at least one of the alias request message or the P2P transfer request message is formatted as a call to the NAP API.

13. The method according to claim 8, wherein the steps further comprise:
in response to the P2P transfer request message, determining whether the second server participates in a P2P service provided by said NAP server;
in response to determining that the second server participates, transmitting information from the P2P transfer request message in a notification message to the second server; and
receiving an approval message from the second server.

14. The method according to claim 8, wherein the steps further comprise:
receiving, from the first server, a second P2P transfer request message specifying a third account number transmitted to the first server by the initiating user;
in response to the second P2P transfer request message, transmitting a second transfer approval message to a second originating institution server, the transfer approval message specifying another one or more payment networks capable of clearing and settling funds between the account of the initiating user and the third account number, wherein the second originating institution server is one of i) a third server associated with a third account-holding institution associated with the third account number or ii) the first server; and
causing initiation of clearing and settlement of a second funds transfer between the account of the initiating user and the third account number via a second DSSN, wherein the second DSSN is one of the specified another one or more payment networks and operates without interaction with said NAP server.

15. At least one non-transitory computer-readable medium for use with a network-agnostic processor (NAP) server and comprising instructions embodied thereon, wherein the instructions are executable by at least one processor of the NAP server to cause the least one processor to:
receive, from a first server associated with a first account-holding institution, an alias request message indicating a request from an initiating user to initiate a transfer, the alias request message including an alias;
in response to the alias request message, query one or more directory servers on the alias, wherein the query returns one or more account numbers associated with the alias;
transmit an alias response message to the first server including the one or more account numbers;
receive, from the first server, a P2P transfer request message specifying one of the one or more account numbers;
in response to the P2P transfer request message, transmit a transfer approval message to an originating institution server, the transfer approval message specifying one or more payment networks capable of clearing and settling funds between an account of the initiating user and the specified account number, wherein the originating institution server is one of i) a second server associated with a second account-holding institution associated with the specified account number or ii) the first server; and
cause initiation of clearing and settlement of a funds transfer between the account of the initiating user and the specified account number via a designated settlement system network (DSSN), wherein the DSSN is one of the specified one or more payment networks and operates without interaction with said NAP server.

16. The at least one non-transitory computer-readable medium according to claim 15, wherein the instructions are further executable to cause the least one processor to cause the initiation of clearing and settlement by transmitting, to the originating server, instructions implementable by the originating server to transfer funds to the specified account number via the DSSN.

17. The at least one non-transitory computer-readable medium according to claim 15, wherein the instructions are further executable to cause the least one processor to cause the initiation of clearing and settlement by sending a transfer initiation request message to a bridge platform associated with the DSSN.

18. The at least one non-transitory computer-readable medium according to claim 17, wherein the bridge platform provides a bridge platform application programming interface (API) for initiating push-to-PAN clearing and settling over the DSSN, and the transfer initiation request message is formatted as a call to the bridge platform API.

19. The at least one non-transitory computer-readable medium according to claim 15, wherein the instructions are further executable to cause the least one processor to provide an NAP application programming interface (API), and at least one of the alias request message or the P2P transfer request message is formatted as a call to the NAP API.

20. The at least one non-transitory computer-readable medium according to claim 15, wherein the instructions are further executable to cause the least one processor to:
receive, from the first server, a second P2P transfer request message specifying a third account number transmitted to the first server by the initiating user;
in response to the second P2P transfer request message, transmit a second transfer approval message to a second originating institution server, the transfer approval message specifying another one or more payment networks capable of clearing and settling funds between the account of the initiating user and the third account number, wherein the second originating institution server is one of i) a third server associated with a third account-holding institution associated with the third account number or ii) the first server; and
cause initiation of clearing and settlement of a second funds transfer between the account of the initiating user and the third account number via a second DSSN, wherein the second DSSN is one of the specified another one or more payment networks and operates without interaction with said NAP server.
